(19) United States
(12) Patent Application Publication
(10) Pub. No.: US 2013/0006896 A1
(43) Pub. Date: Jan. 3, 2013

(54) Training Datasets for Memory Devices

(75) Inventors: Ara Patapoutian, Hopkinton, MA (US); Arvind Sridharan, Longmont, CO (US)

(73) Assignee: SEAGATE TECHNOLOGY LLC, Cupertino, CA (US)

(21) Appl. No.: 13/170,802

(22) Filed: Jun. 28, 2011

(51) Int. Cl. G06F 15/18

(52) U.S. Cl. 706/12

(57) ABSTRACT

Methods and systems involve the use of training datasets to determine one or more reference voltages used to read data in a memory unit. Approaches for accessing a memory device having multiple memory units includes storing a training dataset comprising at least one of a known data pattern and a codeword capable of being decoded in a training dataset field of each memory unit of a memory device. One or more reference voltages are determined using the training dataset stored in the memory unit. After the reference voltages have been determined using the training dataset, these reference voltages are used to read other fields of the memory unit.

### SUMMARY

Methods and systems involve training datasets used to determine one or more reference voltages for reading data stored in a memory unit. According to some embodiments, a method of accessing a memory device having multiple memory units includes storing a training dataset comprising at least one of a known data pattern and a codeword capable of being decoded in a training dataset field of each memory unit of a memory device. One or more reference voltages are determined using the training dataset field of the memory unit. After the reference voltages have been determined using the training dataset, these reference voltages are used to read other fields of the memory unit.

According to some aspects, the training dataset is a known data pattern and the training dataset field is a predetermined location within the memory unit. According to some aspects, the training dataset is the codeword capable of being decoded and the training dataset field is a location of the codeword in the memory unit, i.e., wherever the codeword is located in the memory unit.

Determining the reference voltages can occur in response to a failure of the memory unit to be decoded. In some cases, the training dataset is stored in the memory unit only after the memory unit has experienced a predetermined number of program/erase cycles. For example, the training dataset may be stored in response to at least one of age and disturb mechanisms affecting the memory unit. The age and/or disturb effects can include number of program erase cycles, likelihood of charge disturb effects, page number, page type, and/or retention time, among other factors. In some cases, the code rate of the codeword that is capable of being decoded is a function of a likelihood that data stored in the memory unit will have errors.

Determining the reference voltages may comprise reading multiple codewords stored in a memory unit and identifying the codeword that is capable of being decoded. The successfully decoded codeword is used as the training dataset for the memory unit.

According to some embodiments, a method of accessing a memory device having multiple memory units includes storing codewords in a memory unit of a memory device. The codewords include at least one codeword that has a code rate dependent on a number of program/erase cycles experienced by the memory unit. At least one of the codewords is successfully decoded. The successfully decoded codeword is used to determine one or more reference voltages. After the reference voltages are determined using the successfully decoded codeword, the reference voltages are used to decode other codewords stored in the memory unit.

Some embodiments involve a memory controller. The memory controller includes a training dataset module configured to determine one or more reference voltages using a training dataset stored in a training dataset field of a memory unit. The training dataset includes at least one of a known data pattern and a codeword capable of being decoded. The memory controller also includes a read/write channel control module configured to use the one or more reference voltages determined by the training dataset module to read other fields of the memory unit. According to some implementations, the memory unit comprises multilevel charge-based memory cells.

These and other features and aspects of the various embodiments disclosed herein can be understood in view of the following detailed discussion and the accompanying drawings.

### BRIEF DESCRIPTION OF THE DRAWINGS

FIG. 1A is a flow diagram that illustrates a process for using a training dataset to determine one or more reference voltages used to access a memory unit;

FIG. 1B is a flow diagram that illustrates a process for initiating a determination of one or more reference voltages used to read a memory unit after an attempt to read the memory fails;

FIG. 2A is a block diagram illustrating a memory system capable of implementing the use of a training dataset to determine one or more reference voltages used to access a memory unit;

FIG. 2B is a block diagram that illustrates the memory controller of FIG. 2A in more detail;

FIG. 3A illustrates a voltage shift due to charge loss from a memory cell;

FIG. 3B illustrates a reference voltage shift that compensates for a decrease in memory cell voltage;

FIG. 4A illustrates the use of a known data pattern stored in a memory unit to determine a reference voltage used to read a memory unit;

FIG. 4B is a flow diagram illustrating the configuration of a training dataset field in a memory unit;

FIG. 4C illustrates a memory unit without a training dataset field;

FIG. 4D illustrates a memory unit with a training dataset field and other fields of the memory unit;

FIG. 5A illustrates the use of at least one decoded codeword stored in a memory unit to determine a reference voltage for other parts of the memory unit;

FIG. 5B illustrates a memory unit containing eight codewords having similar or equal code rates; and

FIG. 5C illustrates a memory unit containing eight codewords wherein one codeword has a lower code rate than the other codewords in the memory unit.

### DETAILED DESCRIPTION

Some memory devices that are based on the storage of charge experience charge disturbances and, as a result, shifted reference voltages may be needed for reading the memory device. Attempting to read part of a memory device with an incorrect reference voltage may result in read errors that prevent the decoding of the data. It can be useful to accurately determine read voltages especially during an error recovery mode. In some cases, a training dataset can be stored in a portion of a memory unit of a memory device. The training dataset can be used to determine one or more reference voltages for other portions of the memory unit. Some embodiments disclosed herein describe using a known data pattern as a training dataset. Some embodiments described herein involve attempting to decode one or more codewords stored in a memory unit and using a successfully decoded codeword as the training dataset.

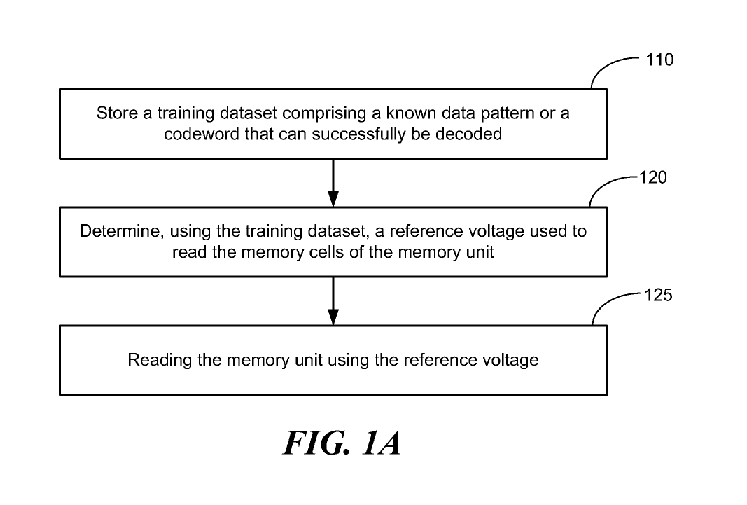

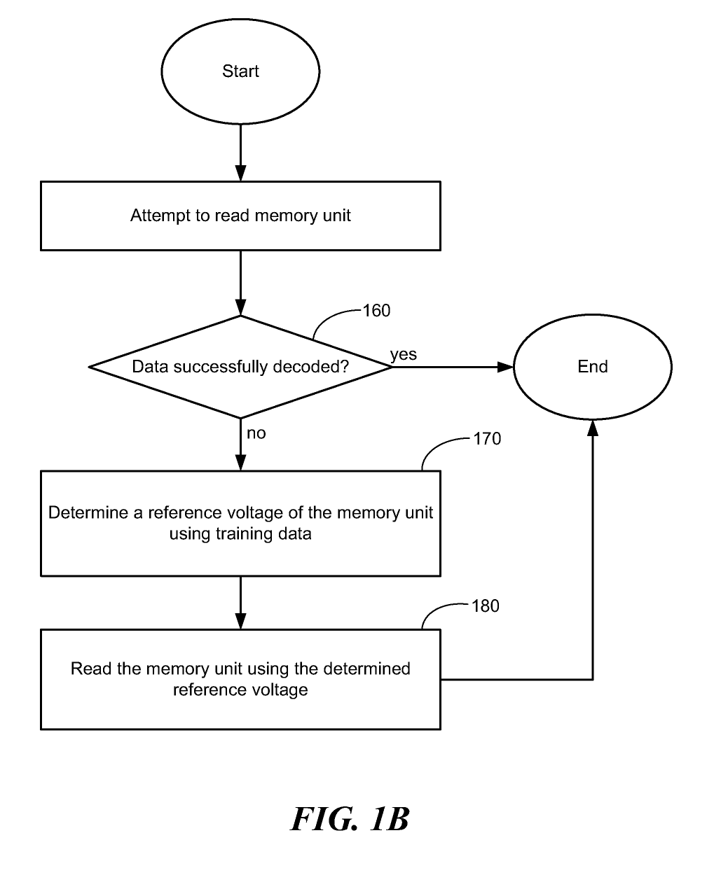

FIG. 1A is a flow diagram that illustrates a process for using a training dataset to determine one or more reference voltages used to access a memory unit. The memory unit may be a page of the memory device, i.e., the smallest read unit of a memory device. Alternatively, the memory unit may be a portion of a page or a group of pages. According to the example illustrated in FIG. 1A, a training dataset is stored 110 in a training dataset field in the memory unit, the training dataset comprising a known data pattern and/or a codeword that can successfully be decoded. One or more reference voltages are determined 120 using the training dataset. After the reference voltages are determined using the training dataset stored in the training dataset field, other fields of the memory unit are read 125 using the reference voltages.

In some implementations determination of the reference voltages is only initiated after an attempt to read the memory unit fails, as illustrated in FIG. 1B. A read process of a memory unit begins 140 and an attempt is made to read 150 the memory unit. A determination 160 is made as to whether data in the memory unit is successfully decoded. If the data stored in the memory unit cannot be successfully decoded 160, one or more reference voltages of the memory unit are determined 170 using a training dataset stored in the training dataset field of the memory unit. After the one or more reference voltages are determined, other fields of the memory unit are read 180 using the reference voltages. If it is determined that the data in the memory unit can be successfully decoded 160, the process ends.

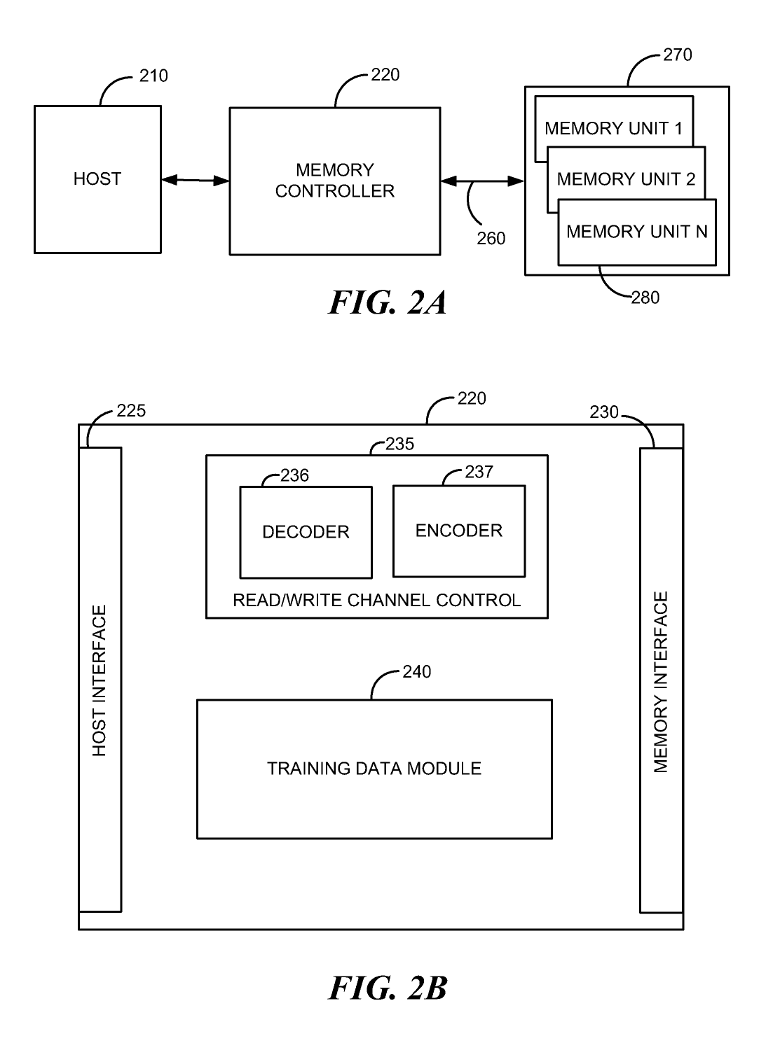

FIGS. 2A and 2B are block diagrams of a system capable of using training datasets to determine one or more reference voltages in accordance with some embodiments described herein. FIG. 1A includes a memory device 270, a host 210, and a memory controller 220. The controller 220 is coupled to the memory device 270 via one or more channels 260. The memory device 270 may correspond, for example, to a solid state, charge-based, non-volatile memory device, e.g., flash memory. Alternatively the memory device may correspond to a magnetic memory device and/or a hybrid memory device. The memory device 270 includes one or more memory units 280. The host 210 can be any type of computing system. The memory controller 220 provides an interface between the memory device 270 and the host 210.

The block diagram of FIGS. 2A and 2B and/or other block diagrams discussed herein show system components divided into functional blocks. It will be appreciated by those skilled in the art that there exist many possible configurations in which these functional blocks can be arranged and implemented. The examples depicted herein provide some possible functional arrangements for system components. For example, in some implementations, all or a portion of the functionality of the memory controller 220 may be included within the host 205. The various approaches described herein may be implemented using hardware, software, or a combination of hardware and software, for example.

FIG. 2B illustrates a more detailed block diagram of the memory controller 220. The memory controller 220 includes a host interface 225 for facilitating the transfer of data between the memory device 270 and the host 210. The memory controller 220 is able to receive memory device access requests from the host 210 via the host interface 225. The memory controller 220 may also include a memory interface 230 that allows the memory controller 220 to access the memory device 270 via the one or more channels 260. A channel is a set of address lines and data lines that selects and accesses a portion of a memory device.

The memory controller 220 may include a read/write channel control unit 235. In some cases, the read/write channel control unit 235 includes an encoder 237 and/or a decoder unit 236. The encoder 237 may encode any data to be stored in the memory device 270 using an error correcting code (ECC). ECC is used to detect and/or correct data errors present in the data when the data is read from the memory device 210. The encoder 237 encodes the incoming data from the host using the ECC into codewords which are made up of the data bits and parity bits (redundant data). The code rate of a codeword is related to the number of parity bits of the codeword. A lower code rate can be achieved by adding more parity bits to a codeword. However, adding more parity bits results in format loss, i.e., loss of available memory in which other, non-parity information, can be stored in the memory device. Codewords with lower code rates are more likely to be able to correct errors because more redundant bits are used.

The encoded data can be stored to the memory device 270 via the memory device interface 230 and the one or more channels 260. When data is to be read from memory, the encoded data is read from the memory device 270 and is decoded using the decoder unit 236. The encoded data is decoded using the ECC and is transferred to the host 210 using the host interface 225. The encoder 237 and decoder 236 units use the ECC to attempt to correct errors that are present in the data read from the memory device 270. The data errors may arise, for example, due to noise during the read and/or write operations and/or due to data corruption caused by charge leakage and/or charge disturb effects that arise from accessing neighboring memory cells as discussed herein.

The system diagram of FIG. 2B also includes a training dataset module 240. The training dataset module 240 uses the training dataset that is stored in the training dataset field of the memory unit to determine one or more reference voltages. In some implementations, the training dataset may include a known data pattern. The training dataset field used to store the known data pattern may be a header field of a memory unit, for example. In some implementations, the training dataset may be a successfully decoded codeword. After the one or more reference voltages are determined using the training dataset stored in the training dataset field of the memory unit, the reference voltages are used to read other fields of the memory unit.

In some cases, it is useful to initiate storage of the training dataset based on the likelihood that the memory unit will experience errors. For example, the memory unit may be more vulnerable to errors as it ages, so the training dataset module can be configured to store the training dataset (known data pattern) only after a predetermined number of program/erase cycles have occurred. In some cases, the training dataset module may select the code rate of at least one of the codewords stored in a memory unit based on the likelihood that the memory unit will experience errors.

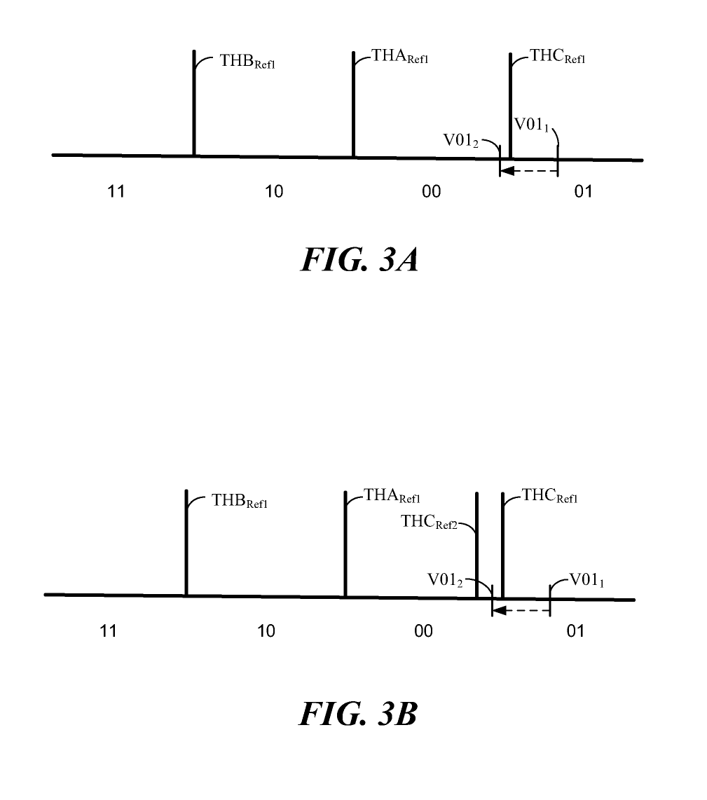

In some implementations, the memory cells of charge-based memory devices are capable of storing one or more bits, each combination of bits corresponding to a particular analog voltage level. FIG. 3A illustrates how these analog voltages may change causing data errors when the data is read from the memory unit.

For purposes of illustration, FIG. 3A depicts a scenario wherein an analog voltage, V01₁, representing the digital symbol 01, has been programmed into a memory cell. Immediately after programming the memory cell, the digital symbol stored in the memory cell can be read by sensing the voltage V01₁ and comparing the voltage V01₁ to a nominal reference voltage THC_{Ref1}. Because V01₁ is greater than the nominal reference voltage THC_{Ref1}, the digital symbol stored in the memory cell is correctly identified and transferred to the memory controller as 01.

However, due to charge leakage or other effects, charge stored in the memory cell can change, causing the voltage of the memory cell to decrease to voltage V01₂. If the memory cell is read after the charge leakage, comparison of the analog voltage V01₂ to the nominal reference voltage, THC_{Ref1} leads to erroneous identification of the digital symbol stored in the memory cell as 00 rather than 01. This erroneous value is transferred from the memory to the memory controller, where the decoder circuitry attempts to decode the data. The data may include too many errors and may not be successfully decoded.

In the scenario described in connection with FIG. 3A, the voltage change from V01₁ to V01₂ may be taken into account and compensated for by shifting the reference voltages used to read the data. For example, as illustrated in FIG. 3B, lowering the reference voltage from the nominal reference voltage, THC_{Ref1}, to a shifted reference voltage, THC_{Ref2}, allows the digital symbol represented by V01₂ to be correctly interpreted as 01 rather than erroneously interpreted as 00. Comparison of the analog voltage V01₂ to shifted reference voltage THC_{Ref2} indicates that V01₂ is greater than THC_{Ref2} leading to the correct interpretation of the digital symbol stored in the memory cell as 01. As described in embodiments herein, the training dataset is used to determine reference voltages that compensate for disturbances in the charge stored in the memory cells.

Determining the reference voltages may involve calculating the amount of voltage shift from the nominal reference voltage based on configuration and use factors of the memory cells of a memory unit. The configuration and use factors may include the physical and material configuration of the memory cells of a memory unit, e.g., dimensions, thickness, and doping, etc., the charge currently stored on the memory cells (also expressed as the voltage of the memory cell), the history of program/erase cycles experienced by the memory unit, the type of data page, e.g., MSB page or LSB page, the page number, the history of data errors of the memory unit, the history of read, write, and erase operations performed on other memory units that can potentially affect the charge stored on the cells of the memory unit, the length of time that data has been stored in the memory unit, the temperature of the memory unit at the time of the program operation, the temperature of the memory unit at the time of the read operation, and/or other configuration and use factors. In some implementations, the reference voltage control circuitry in the training dataset module may calculate the voltage shift as a function of only one of these configuration and use factors, e.g., data retention time. In some implementations, the reference voltage control circuitry may calculate the voltage shift as a function of multiple configuration and use factors.

The configuration and use factors may operate interdependently. For example, the rate of charge leakage from a memory cell may increase with the number of program/erase cycles experienced by the memory cell. Analog voltages representing certain data symbols may make the memory cell more susceptible to charge loss or charge gain than other analog voltages that represent other data symbols.

The shift in the voltage of a memory cell, Δ_{P}, due to use factors U₁, U₂, U₃, . . . U_{J} may be determined using the charge loss/gain model of the memory cell, expressed as f(U₁, U₂, U₃, . . . U_{J}), where U₁, U₂, U₃ . . . U_{J} are use factors such as those listed above. The amount of change of the voltage stored in a memory cell due to each use factor U₁, U₂, U₃, . . . U_{J} may be estimated based on an a priori characterization of a population of similar memory units before the memory unit is in use, or may be estimated based on an a posteriori characterization of the memory unit (or other similar memory units of the same memory device) during the time that the memory unit is in use. For example, when a priori population data is used, then the shifted reference voltage may be calculated:

VRef_{shifted}=VRefₙₒₘᵢₙₐₗ+Δ_{P}

where Δ_{P} is the expected voltage shift determined using the charge/loss gain model f(U₁, U₂, U₃, . . . U_{J}) of the memory cell derived from population data.

In some implementations, some or all of the memory units of a memory device may be characterized to model the charge loss/charge gain behavior a posteriori, i.e., during the time that the memory device is in use. For example, characterization of the memory units may be performed during an appropriate time, such as during garbage collection. The shifted reference voltages may then be calculated based on the characterization of the memory cells. Characterization of the memory units may occur numerous times over the life of the memory device, allowing rates of change in charge loss or gain behavior for each use factor or multiple use factors to be calculated. These calculated rates of change can be used to extrapolate the expected changes from the use factors.

For example, when a posteriori memory cell characterization data is used, then the shifted reference voltage may be calculated:

VRef_{shifted}=VRefₙₒₘᵢₙₐₗ+Δ_{C},

where Δ_{C} is the expected voltage shift determined using the charge loss/gain model, f(U₁, U₂, U₃, . . . U_{J}) of the memory cell derived from one or more characterization of the memory cell or memory cell array. In some implementations, the charge loss/gain model of the memory unit may be derived using a priori population data for use some factors and a posteriori characterization of the memory unit for other use factors. In some implementations, the charge loss/gain model may be adaptive. For example, a priori population data may initially be used to generate the charge loss/charge gain model, but as characterization data for the memory unit is acquired, the charge loss/charge gain model may increasingly rely on the information acquired from the a posteriori characterization.

After the training dataset is read from the memory, it is decoded which generates errors. Since the data of the training dataset is known, information about the shifts needed in the reference voltages can be discerned.

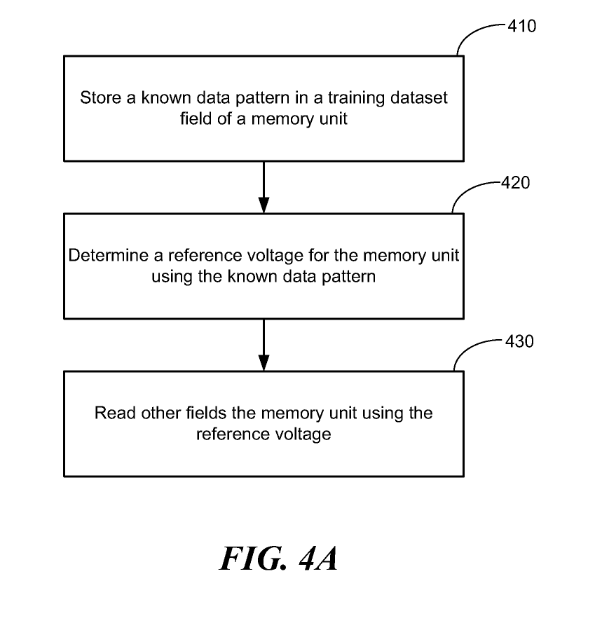

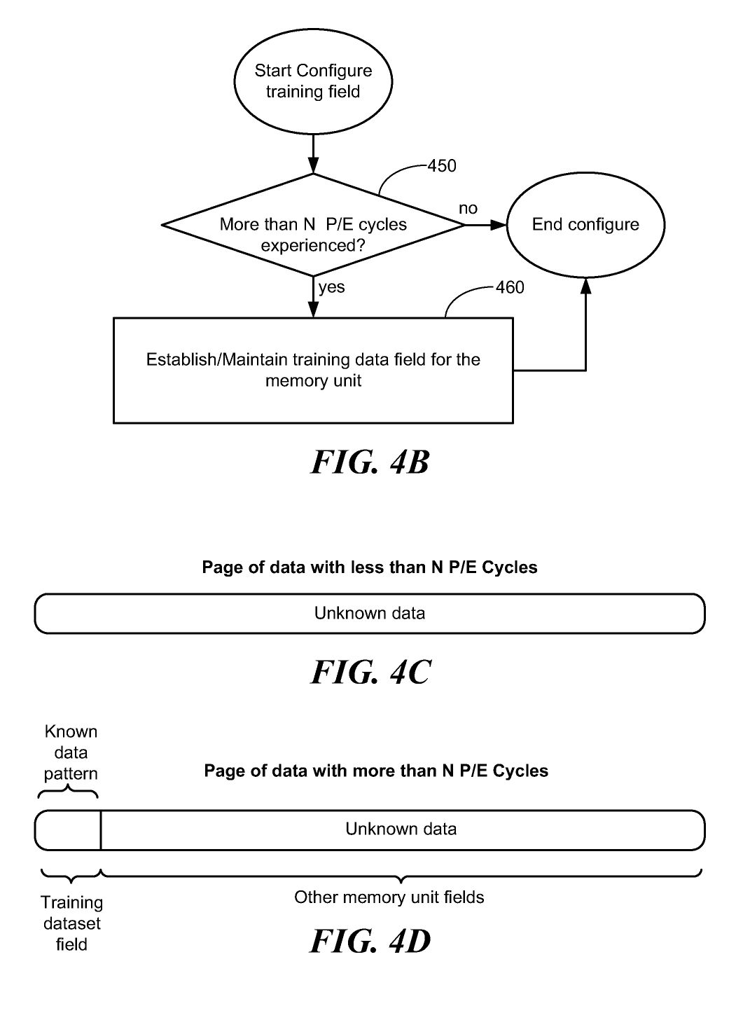

FIGS. 4A-4D illustrate the use of a known data pattern stored in a memory unit to determine a reference voltage for the memory unit. For example, in the process shown in FIG. 4A a known data pattern is stored 410 in a training data field of a memory unit. A reference voltage for the memory unit is determined 420 using the known data pattern stored in the training data field. Other fields of the memory unit are read 430 using the reference voltage determined using the training data.

In some cases, the known data pattern is not stored in the memory unit until a parameter associated with the memory unit is beyond a threshold. For example, the training dataset field may be used for the memory unit after the memory unit has experienced a predetermined number of program/erase (P/E) cycles. In this case, format loss at the beginning of life, when failure of the memory unit is rare, is prevented. The training dataset field may be field in the header of the memory unit or the training dataset field may be located elsewhere in the memory unit.

FIG. 4B is a flow diagram illustrating the configuration of a training dataset field in a memory unit. The process for configuring the training dataset field includes a determination 450 as to whether the memory unit has experienced more than N P/E cycles. If more than N P/E cycles have occurred 450 for the memory unit, a training dataset field is established and/or maintained 460 for the memory unit. If the memory unit has not experienced 450 more than N P/E cycles, then no training data field is used in the memory unit. FIGS. 4C and 4D respectively illustrate a memory unit without a training dataset field and a memory unit with a training dataset field. FIG. 4D illustrates the training dataset field as being at the beginning of the memory unit, but it will be appreciated that the training data field may exist anywhere within the memory unit. FIG. 4D illustrates other fields of the memory unit.

As previously mentioned, in some cases, the training dataset may comprise a decoded ECC codeword. Data to be stored in a memory unit of a memory device is encoded into one or more ECC codewords. For example, the data stored in a memory unit may be encoded into eight codewords. In some cases the codewords have a similar or equal code rate. In some cases, one or more of the codewords stored in a memory unit have a lower code rate than other codewords stored in the memory unit. This difference in code rate may help to ensure that at least one of the codewords is able to be decoded. A codeword that is successfully decoded may be used to determine the one or more reference voltages that are used to read other codewords stored in the memory unit.

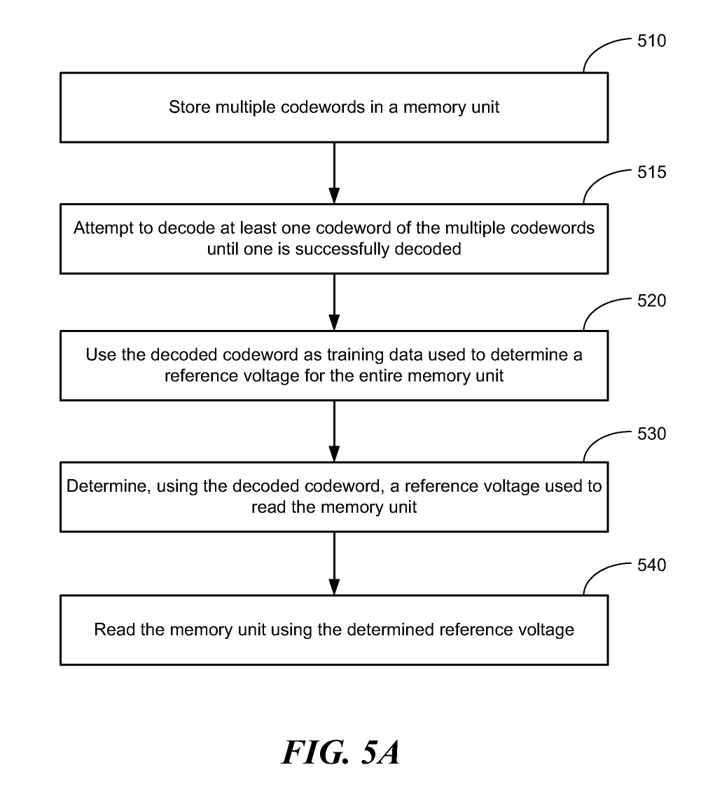

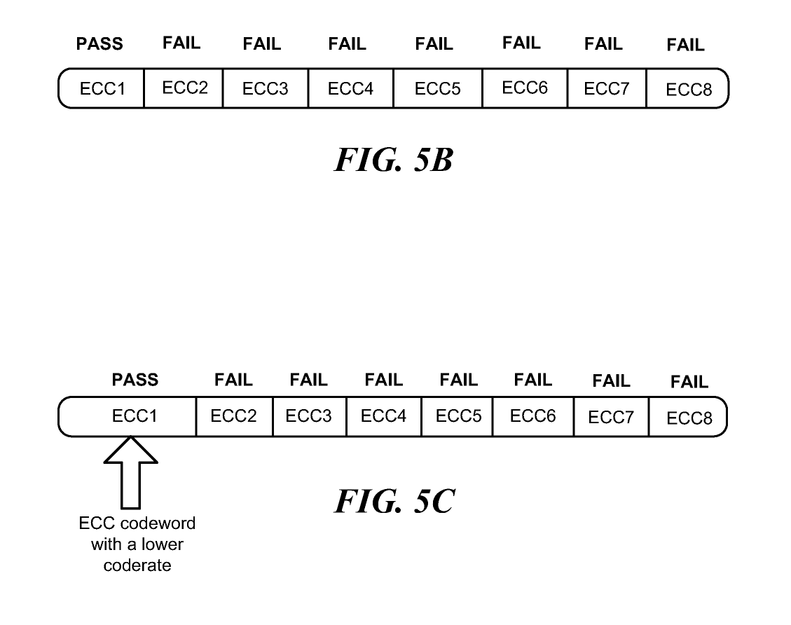

FIGS. 5A-5C illustrate the use of at least one decoded ECC codeword stored in a memory unit to determine a reference voltage for other parts of the memory unit. According to FIG. 5A, multiple codewords are stored 510 in a memory unit. The process attempts 515 to decode each of the multiple codewords until at least one of the codewords is successfully decoded. Once at least one codeword has been successfully decoded, the decoded codeword is used 520 as a training dataset for the memory unit to determine 530 at least one reference voltage. After the reference voltage is determined, it is used to read other codewords in the memory unit. Thus, in this example, the training dataset field is located in the memory unit wherever the successfully decoded codeword is stored. Other fields in the memory unit contain other codewords and these codewords are read 540 using the reference voltage. In some cases, multiple codewords are initially decoded and could potentially be used as the training dataset. In these cases, multiple decoded codewords may be used as the training dataset or a codeword that was decoded with the least amount of error correction or achieves some other figure of merit in the decoding process may be used as the training dataset.

FIG. 5B illustrates a memory unit with eight codewords. This example shows that ECC1 was able to be decoded and ECC2-ECC8 were not able to be decoded. In this case, ECC1 is used as the training dataset to determine the reference voltages which are subsequently used for all of the other codewords stored in the memory unit.

As described previously, in some cases, one or more of the codewords stored in the memory unit may have a lower code rate than other codewords stored in the memory unit. The codeword size can be the same or can be different. FIG. 5C illustrates an example in which ECC1 has a lower code rate than each of ECC1-ECC8. Having a lower code rate makes it more likely that a codeword will be decoded. As indicated in FIG. 5C, ECC1 is able to be decoded while each of ECC2-ECC8 are not able to be decoded. However, a lower code rate does not necessarily ensure that the codeword with the lower code rate can be decoded. Thus, in some cases, one or more of ECC2-ECC8 may be able to be decoded while ECC1 is not able to be decoded, even though ECC1 has a lower code rate.

Charge based memory cells in general are more vulnerable to charge disturbances as they age. Thus, for a younger memory unit, a higher code rate codeword can be successfully decoded, whereas an older memory unit would require a lower code rate codeword. When the memory unit is new, it is useful to use a higher code rate because the redundancy is not needed and additional data can be stored instead of parity bits. However, as the memory unit ages, it becomes useful to store more parity bits so that it is more likely a codeword can be decoded and used to determine reference voltages for the other codewords of the memory unit.

In some implementations, it is useful to adjust the code rate of at least one of the codewords stored in the memory unit based on the likelihood that the memory unit will experience charge disturbances. As discussed above, factors that may increase the likelihood of errors can include, program erase cycles, charge disturb effects, page number of the memory unit (address location within a block of pages), and retention time. Charge disturbances are more likely as the memory unit ages, for example, so the code rate may be varied based on number of P/E cycles. As another example, charge disturbances of certain pages, e.g., higher number pages in a block, may be more vulnerable to charge disturbances. Thus, the code rate of at least one of the codewords in a page may be selected based on the page number of the memory unit. As yet another example, the code rate of at least one of the codewords may be selected based on the bit error rate (BER) previously experienced by the memory unit. In some implementations, only one or only some (e.g., less than 8, 16, 24) of the codewords stored in the memory unit have the lower code rate so that these codewords are more likely to be decoded and used to determine reference voltages for the other, higher code rate codewords in the memory unit.

It is to be understood that this detailed description is illustrative only, and various additions and/or modifications may be made to these embodiments, especially in matters of structure and arrangements of parts. Accordingly, the scope of the present disclosure should not be limited by the particular embodiments described above, but should be defined by the claims set forth below and equivalents thereof.

What is claimed is:

1. A method of accessing a memory device having multiple memory units, comprising:
storing a training dataset comprising at least one of a known data pattern and at least one codeword capable of being decoded in a training dataset field of each memory unit of a memory device;
determining one or more reference voltages using the training dataset field of the memory unit; and
using the reference voltages to read other fields of the memory unit.

2. The method of claim 1, wherein the training dataset is the known data pattern and the training dataset field is a predetermined location within the memory unit.

3. The method of claim 1, wherein the training dataset is the codeword capable of being decoded and the training dataset field is a location of the codeword in the memory unit.

4. The method of claim 1, wherein the determining occurs in response to failure of the memory unit to be decoded.

5. The method of claim 1, wherein storing the training dataset comprises storing the training dataset only after the memory unit has experienced a predetermined number of program/erase cycles.

6. The method of claim 1, wherein storing the training dataset comprises storing the training dataset in response to a likelihood of at least a one of age and disturb mechanisms affecting the memory unit.

7. The method of claim 1, wherein:
multiple codewords are stored in the memory unit; and
determining reference voltages comprises:
reading the multiple codewords;
identifying the codeword that is capable of being decoded; and
using the codeword that is capable of being decoded as the training dataset for the memory unit.

8. The method of claim 1, wherein the codeword that is capable of being decoded has a code rate that is lower than other codewords of the memory unit.

9. The method of claim 8, wherein the code rate of the codeword that is capable of being decoded is a function of a likelihood that data stored in the memory unit will have errors.

10. The method of claim 9, wherein the likelihood of errors is based on one or more of program/erase cycles, charge disturb effects, page number, and retention time.

11. A method of accessing a memory device having multiple memory units, comprising:
storing codewords in a memory unit of a memory device, the codewords including a least one codeword that has a code rate dependent on a number of program/erase cycles experienced by the memory unit;
successfully decoding the at least one codeword;
determining a reference voltage for the memory unit using the successfully decoded codeword; and
using the reference voltage to read other codewords of the memory unit.

12. The method of claim 11, wherein the code rate of the at least one codeword decreases with increasing program/erase cycles experienced by the memory unit.

13. A memory controller, comprising:
a training dataset module configured to determine, for each memory unit of a memory device, one or more reference voltages using a training dataset stored in a training dataset field of the memory unit, the training dataset comprising at least one of a known data pattern and at least one codeword capable of being decoded; and
a read/write channel control module configured to use the one or more reference voltages determined by the training dataset module to read other fields of the memory unit.

14. The memory controller of claim 13, wherein the memory unit comprises multilevel charge-based memory cells.

15. The memory controller of claim 13, wherein the training dataset module is configured to initiate storage of the known data pattern only after the memory unit has experienced a predetermined number of program/erase cycles.

16. The memory controller of claim 13, wherein:
multiple codewords are stored in the memory unit; and
the training dataset module is configured to identify the codeword of the multiple codewords that is capable of being decoded as the training dataset.

17. The memory controller of claim 16, wherein the training dataset module is configured to determine a code rate for at least one of the multiple codewords stored in the memory unit based on a likelihood that the multiple codewords stored in the memory unit will experience errors.

18. The memory controller of claim 17, wherein the training dataset module is configured to determine the code rate based on a number of program/erase cycles experienced by the memory unit.

19. The memory controller of claim 13, wherein the training dataset is the known data pattern and the training dataset field is a predetermined location within the memory unit.

20. The memory controller of claim 13, wherein the training dataset is the codeword capable of being decoded and the training dataset field is a location of the codeword in the memory unit.
